(19) United States
(12) Patent Application Publication
(10) Pub. No.: US 2010/0116513 A1
(43) Pub. Date: May 13, 2010

(54) Storage tank fire suppression system

(76) Inventor: Charles Allen Phillips, Rising Star, TX (US)

Correspondence Address: MEGAN LYMAN, 1816 SILVER MIST CT., RALEIGH, NC, 27613, US

(21) Appl. No.: 12/291,692

(22) Filed: Nov. 13, 2008

(51) Int. Cl. A62C 35/02; A62C 3/06; A62C 37/11

(52) U.S. Cl. 169/51; 169/66; 169/26

(57) ABSTRACT

The invention provides a self contained firefighting apparatus that is mounted on the side of a storage tank. This firefighting device employs a cylinder of compressed gas used as the driver for the “Aqueous Film Forming Foams” (AFFF) that is released by a bladder or piston system once the heat sensor located at the end of the dispensing outlet pipe is activated. A predetermined amount of the AFFF agent⁵ is then distributed onto the inferno depriving the fire of the necessary oxygen needed to fuel the continued combustion, thereby extinguishing the fire within seconds. ⁵ The amount of AFFF agent needed is based upon the particular or specific circumference of the storage tank requiring the storage tank fire suppression system.

This invention autonomously suppresses storage tank fires where previous conflagration needed human intervention i.e., gasoline, oil or any combustible material storage in tanks.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to storage tank fire suppression system and more particularly to a mounted, self contained fire suppression device serving as a storage tank fire suppression unit. This invention autonomously suppresses storage tank fires where previous conflagration needed human intervention.

2. Background

The photo on the right was taken by Fire units from Sour Lake Fire, Pine Ridge Fire, Pinewood Fire, Bevil Oaks Fire, Nome Fire, China Fire, Lumberton Fire, SUNOCO Transfer/Storage Station and Milstead environmental battled an oil tank battery fire in the pouring rain.

Unlike previous responses when a fire extinguisher could be used to extinguish this type of fire, lightning had blown the roof off of one of the tanks and ignited the oil inside. The fire quickly spread to a second of six tanks located inside the tank containment levee. With the roof missing from one of the involved tanks combined with the fire and heavy rain, the primary concern was the potential for a boil over explosion. (A boil over explosion is when the water below the oil turns to steam and erupts like an oil volcano.) Further compounding the problems surrounding this fire was the remote location of the incident and the lack of water supply making these fires an overwhelming event. If the storage tank containing the flammable or combustible materials had the complete fire suppression unit installed the subsequent lightning event would have immediately released the “Aqueous Film Forming Foams” (AFFF) material depriving the fire of the necessary oxygen needed for fueling the fire, thereby extinguishing the blaze within seconds.

### DETAILED DESCRIPTION OF THE INVENTION

The current invention provides a self contained, autonomously sensory activation fire extinguishing system designed specifically for storage tank fire suppression. It is the primary objective of the system to be mounted on the external portion of the storage tank, thereby providing protection against unintended fires where a human presence is unavailable to detect such fires.

It is a further objective of the invention to construct the AFFF containment system in a manner that utilizes well known principles of science to physically contain and extinguish the blaze within seconds.

It is a further objective of the invention to use heat activated sensors to release AFFF material into the storage tank fire depriving the fire of oxygen needed for fueling the fire, thereby extinguishing it.

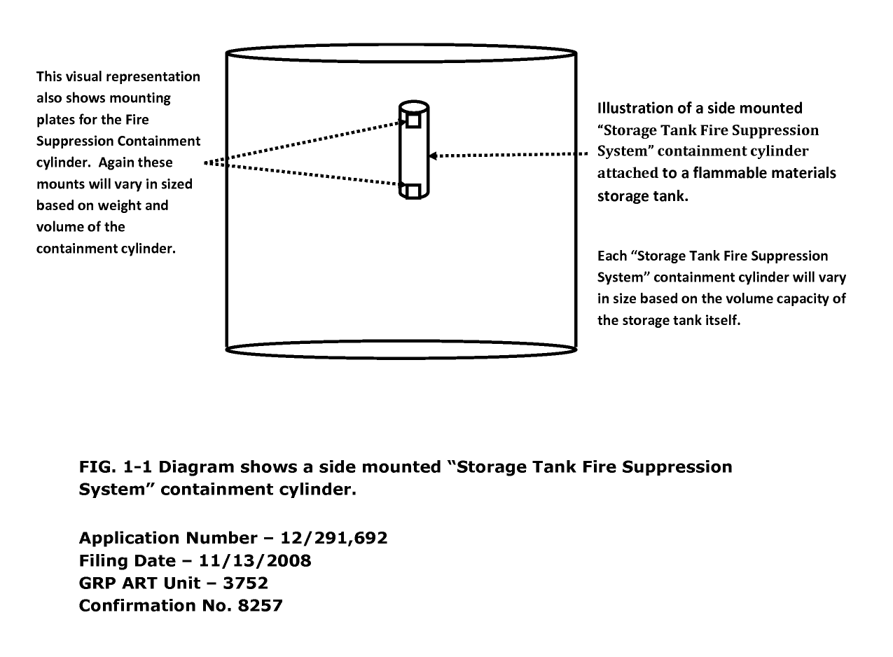

In Operation
It is a further objective of the invention to follow a sequence of deployment as follows:
1. Calculate the diameter of the storage tank
2. Fill the containment cylinder with the correct portion of AFFF material needed to suppress the fires for the diameter of the storage tank calculated
3. Fill the compressed gas bladder inside the containment cylinder creating a sealed pressurized system
4. Mount the self contained fire suppression unit to the top outside part of the storage tank (See FIG. 1-1 page 10)
5. Fit the dispensing pipe to the fire suppression unit, extending the pipe into the storage tank
6. Mount the heat sensor to the nozzle of the dispensing outlet mounted at the top of the storage tank, above the maximum level of flammable material.

It is a further object of the invention to follow the below deployment sequence to initialize the suppression sequence:
1. With the breakdown of the heat sensor,
2. The pressurized containment cylinder drives AFFF material through a dispensing pipe,
3. Deployment of the AFFF material is through the nozzle and into the oil storage tank,
4. Forming a blanket of AFFF material,
5. Cessation of oxygen to the flame, and
6. Extinguishes the blaze within seconds

The following are the general specifications for the first embodiment of the invention:

1. (FIG. 1-1)¹ The side mounted AFFF containment cylinder as depicted will vary in size depending on the volume of the storage tank and the necessary amount of AFFF material needed to suppress a fire for the diameter and volume of the storage tank itself. ¹ Page 10

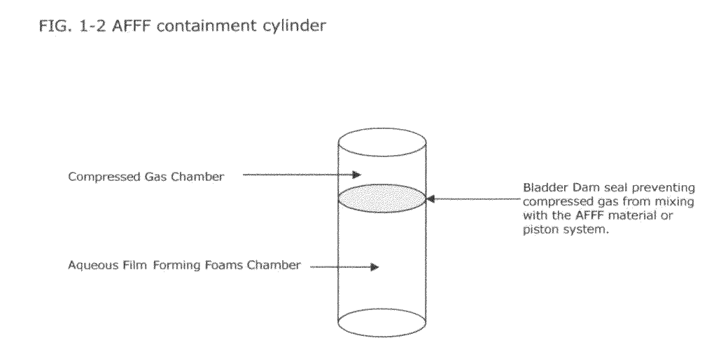

2. (FIG. 1-2)² The AFFF containment cylinder will vary in size to meet the need of the specific storage tank. ² Page 11

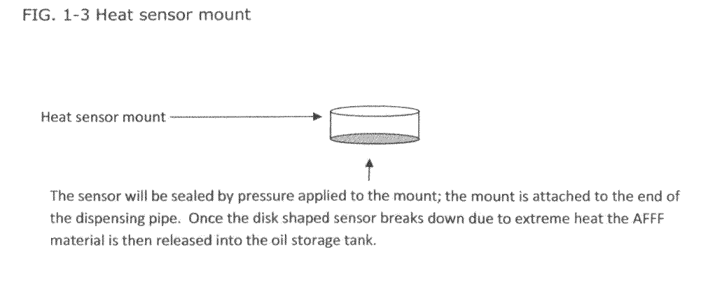

3. (FIG. 1-3)³ The heat sensor mount will vary in size depending on the nozzle size needed for suppressing the fire for the storage tank size and volume. The pressurized tank and dispensing pipe will seat the sensor and seal the AFFF from leakage, once heat causes the breakdown of the sensor the AFFF material will be released into the storage tank, thereby extinguishing the blaze within seconds. ³ Page 12

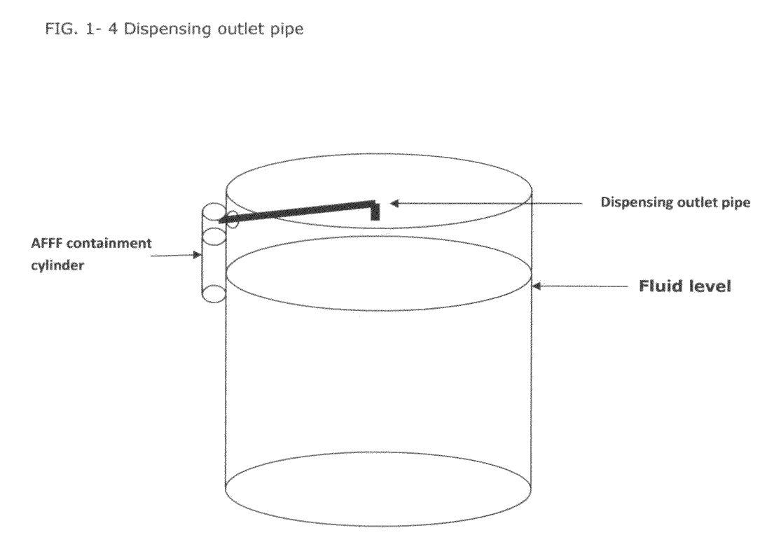

4. (FIG. 1-4)⁴ Dispensing outlet pipe will vary in size again depending on the amount of AFFF material needed to pass through the pipe for suppressing fires for the size and volume of the storage tank. ⁴ Page 13

What is claimed:

1. The said storage tank fire suppression system comprising of the following:
1. An AFFF containment cylinder being closed at one end with an adjustable opening at the other end allowing for a plurality of connecting pipes that extend into the storage tank. The AFFF containment cylinder also having an internal bladder or piston release system for dispensing the AFFF material into the storage tank.
2. A storage tank fire suppression system and containment cylinder of claim 1 wherein a heat sensor is mounted at the end of the suspended pipe in the storage tank sealing the dispensing outlet (See FIG. 1-4 page 13) for the pressurized AFFF cylinder and plurality of connecting pipes into the storage tank that is activated by the heat of the burning fluid.
3. A storage tank fire suppression system and AFFF containment cylinder of claim 1 wherein a mounting plate is attached to the outer surface of said AFFF containment cylinder for mounting to the outer surface of the storage tank preparing the cylinder to counter conflagration.
4. A heat activated sensor at the end of the dispensing pipe inside the storage tank will release the AFFF material from the containment cylinder after exposure to the heat of the burning substance.
